(19) United States
(12) Patent Application Publication
(10) Pub. No.: US 2010/0114940 A1
(43) Pub. Date: May 6, 2010

(54) SELF-ORGANIZING MANAGED RESOURCES

(76) Inventors: Scott Alan Isaacson, Woodland Hills, UT (US); Stephen R. Carter, Spanish Fork, UT (US); Tammy Anita Green, Provo, UT (US)

Correspondence Address: SCHWEGMAN, LUNDBERG & WOESSNER/NOVELL, PO BOX 2938, MINNEAPOLIS, MN, 55402, US

(21) Appl. No.: 12/258,577

(22) Filed: Oct. 27, 2008

(51) Int. Cl. G06F 7/06; G06F 17/30

(52) U.S. Cl. 707/769; 707/E17.108

(57) ABSTRACT

Techniques for self-organizing managed resources are provided. A search that defines characteristics of a source resource is automatically constructed. The search is processed to obtain one or more target resources that are similar to the source resource. The source resource and the one or more target resources form a dynamic managed group that is used to monitor and manage the target resources and the source resource as a logical group.

### BACKGROUND

Most business, educational, community, and government organizations rely on computer systems to support their business processes. These computer systems have to be deployed and managed by sizable support personnel. Additionally, many organizations require more than one computer system, which is often deployed as a suite and which generally acts in a coordinated manner to realize complex business processes and transactions. These distributed systems are contained within protected zones and bounded within firewalls and access points. But, within the protected zones there is often open communication and cooperation between various managed systems and the services that they host.

The managed systems are often discrete and are capable of acting in concert with other services for providing higher-level composite services. Also, these systems are of various hardware architectures and operating systems, which operate within heterogeneous environments and which offer individual services on presumably the most efficient, reliable, or cost effective architectural platforms.

However, there are few organizations that act/operate with one mind from the top down. Likewise, an organization's managed system may often include many isolated data centers and workgroup productivity centers deployed as duplicate and redundant servers and services. This is done by the enterprise, without really knowing what is already available. In some cases, a new server needs to be deployed having a certain version of an operating system, which supports a unique application and that can only run on a particular device; but, again, the application acts in a coordinated manner with other services that are deployed within the organization.

For example, take a real world scenario of a customer and partner-facing World-Wide Web (WWW) portal for a given enterprise. This would likely need the following components:
Web server(s)
Authentication server(s)
Middle-tier application server(s)
Database server(s)
And other such components.

These n-tier systems are well understood within the industry, but require real systems to deploy them. In this example, perhaps the fastest performing web server is an Apache running on an openSUSE Linux server, and the best authentication server is Novell eDirectory® running on a NetWare® 6.5 server and the best middle tier application server is some custom application running on Novell SLES 10 and the database server is an Oracle® database running on Solaris® on a Sun® server. Each of these servers is based on hardware that is different from the others in many respects. Some processors are IA32 or IA64 and some are SPARC®. Some operating systems (OS's) are closed source and proprietary, while some are open source. A certain department within the organization decides to deploy these servers and services, but they must be maintained and supported and so the organization hires a variety of qualified staff to monitor these servers and services. The hired systems managers often use proprietary, open source, and open standards-based tools such as OpenView, DMTF CIMOM, SNMP, iManager, YaST, command line tools, scripts, and/or other tools to monitor and manage the servers and services.

Problems arise when not just one department within an enterprise deploys these various servers and services, but when multiple departments within the same enterprise do the same thing as one another. When this happens, there are two web servers, two database servers, two authentication services. Many solutions exist today to synchronize data between these systems, but a problem still remains when multiple Information Technology (IT) staff and resources are assigned to manage servers and services that perhaps should and probably could be consolidated together.

Another issue is when a systems manager locates various servers and services (IP address, LAN subnet, URL, port, or other location/identification mechanism) and then groups them into management groups that make sense to that system administrator, but perhaps does not make sense to another systems administrator from another department.

Still another situation arises when a specific situation arises with a particular system and an administrator wants to find out how widespread the situation is. To do this, the administrator has to engage in a lot of manual network mining and often times by the time the administrator is able to get a handle on the pervasiveness of the situation, the situation changes and it becomes a moot point.

Thus, improved techniques for system management are needed.

### SUMMARY

In various embodiments, techniques for self-organizing managed resources are provided. More specifically, and in an embodiment, a method is provided for locating and organizing similar resources of a network. Search criteria are received for defining attributes of a source resource. A self-organizing server is searched with the search criteria. A target reference to a target resource is received, the target reference is returned by the self-organizing server in response to the search criteria. Finally, the target reference is added to a managed group that includes a source reference to the source resource.

### BRIEF DESCRIPTION OF THE DRAWINGS

FIG. 1 is a diagram of a method for locating and organizing similar resources of a network, according to an example embodiment.

FIG. 2 is a diagram of another method for locating and organizing similar resources of a network, according to an example embodiment.

FIG. 3 is a diagram of self-organizing resource system, according to an example embodiment.

FIG. 4 is a diagram of another self-organizing resource system according to an example embodiment.

### DETAILED DESCRIPTION

A “resource” includes a user, content, a processing device, a node, a service, an application, a system, a directory, a data store, groups of users, combinations of these things, etc. Resources can interact with each other and can either act on other resource or be acted upon by other resources. The term “service” and “application” may be used interchangeably herein and refer to a type of software resource that includes instructions, which when executed by a machine performs operations that change the state of the machine and that may produce output.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The phrases “managed resource,” “managed service,” and “managed system” may be used interchangeably and synonymously herein and below. These are special resources that are managed and monitored by a network administrator. These can include such things as servers, proxies, storage devices, email services, etc. The resources that are managed are dispersed over a network, such as the Internet and/or an enterprise Intranet, etc.

As will be explained in greater detail herein and below, the managed resources are dynamic such that they change and evolve in real time as conditions change with them on the network. The resources are located and dynamically organized into groups in accordance with how similar the resources are to a source resource.

Various embodiments of this invention can be implemented in existing network architectures, security systems, data centers, and/or communication devices. For example, in some embodiments, the techniques presented herein are implemented in whole or in part in the Novell® network, proxy server products, email products, operating system products, data center products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

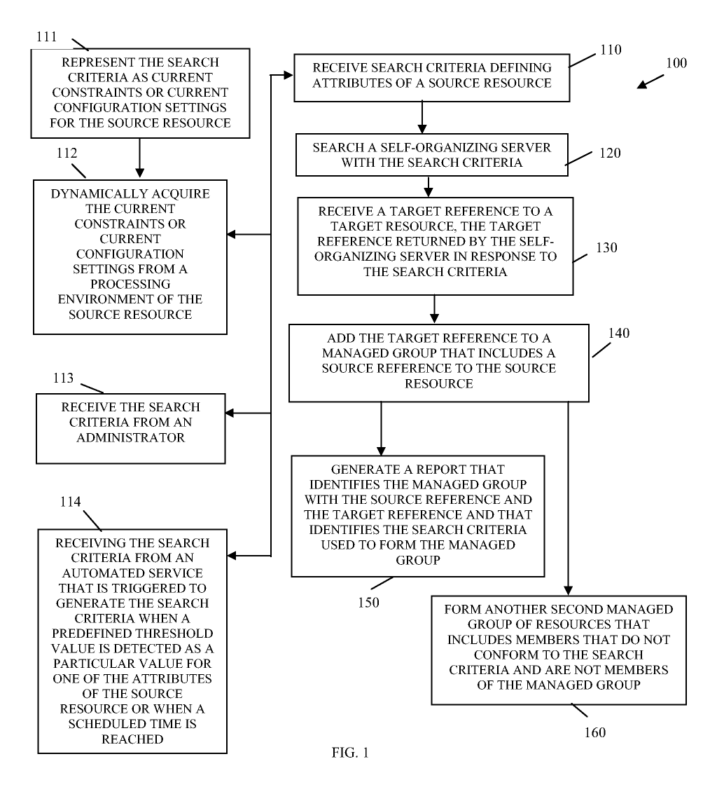

It is within this context, that various embodiments of the invention are now presented with reference to the FIGS. 1-4.

FIG. 1 is a diagram of a method 100 for locating and organizing similar resources of a network, according to an example embodiment. The method 100 (hereinafter “source locator service”) is implemented as instructions in a machine-accessible and computer-readable storage medium. The instructions when executed by a machine (computer or processor-enabled device) perform the processing depicted in FIG. 1. The source locator service is also operational over and processes within a network. The network may be wired, wireless, or a combination of wired and wireless.

At 110, the source locator service receives search criteria defining attributes of source resource. This can be done in a variety of manners and include a variety of information.

For example, at 111, the source locator service represents the search criteria as current constraints or current configuration settings for the source resource.

In a particular case of 111 and at 112, the source locator service dynamically acquires the current constraints or current configuration settings from a processing environment of the source resource.

The current constraints may be such things as a certain percentage of available disk space within the processing environment of the source resource, processor load, bandwidth load or availability, etc. The configuration settings can identify such things as types of operating systems, types of services, etc. that are available to the source resource.

According to an embodiment, at 113, the source locator service receives the search criteria from an administrator. That is, an administrator manually defines the search for the source locator service and submits it to the source locator service for processing.

In another case, at 114, the source locator service receives the search criteria from an automated service. The automated service is triggered to generate the search criteria when a predefined threshold value or policy is detected in view of a particular value for one of the attributes of the source resource. For example, suppose that the available disk space for the source resource falls below a certain threshold of say 10%, this can trigger the automated service to generate the search criteria for locating similar resources to harvest a group of these resources to more efficiently utilize disk space. The automated service contacts the source locator service with the search criteria. A trigger can also occur when a scheduled time is reached or detected.

As another example scenario, consider a custom application knows that it should synchronize its data with all other network instances of the custom application, but search criteria discovers another instance of that application that is not being synchronized. As is discussed more completely below, this information can be used to make a report or organize groups of the applications for those that are being synchronized and those that are not. An administrator can use this to proactively ensure the rogue application instances are being synchronized.

At 120, the source locator service searches a self-organizing server with the search criteria. The self-organizing server is an index repository having information related to the source resource and other resources of the network. The information is in free text format and available for text searching, via any searching mechanism such as World-Wide Web (WWW) searching engines (Google®, etc.).

In response to the search, at 130, the source locator service receives a target reference to a target resource. That is, the target reference is returned by the self-organizing server to the source locator service in response to the submitted search criteria.

At 140, the source locator service adds the target reference to a managed group that also includes a source reference to the source resource. So, a managed group of resources is dynamically established in real time and includes the original source resource and the target resource found. This can then be dynamically managed as a local group of resources that are similar to one another, similar in that they conform in some form to the search criteria.

It is noted that the search criteria can include a series of Boolean OR operations, such that it is inclusive of any satisfied condition defined within the search criteria. In other cases, when desired the search criteria can be more restrictive and include a series of Boolean AND operations, such that each condition is satisfied from the search criteria. The search criteria can also be a combination of OR and AND operations, with varying degrees of complexity.

In an embodiment, at 150, the source locator service identifies a report that identifies the managed group with the source reference and the target reference. The report can also include the search criteria that were used to form the managed group. This may be useful to an administrator to see how and why a particular managed group of similar resources was established and why it includes the members that it does.

In another case, at 160, the source locator service forms another second group of managed resources that are not members of the managed group and that do not conform to the search criteria. So, two sets of groups can be automatically self organized one set that conforms to the search criteria and include those resources that so conform and another set that does not conform to the search criteria. Such an arrangement may be useful to identify rogue resources, as was discussed above with the example application that was to synchronize its data with other instances of the same application.

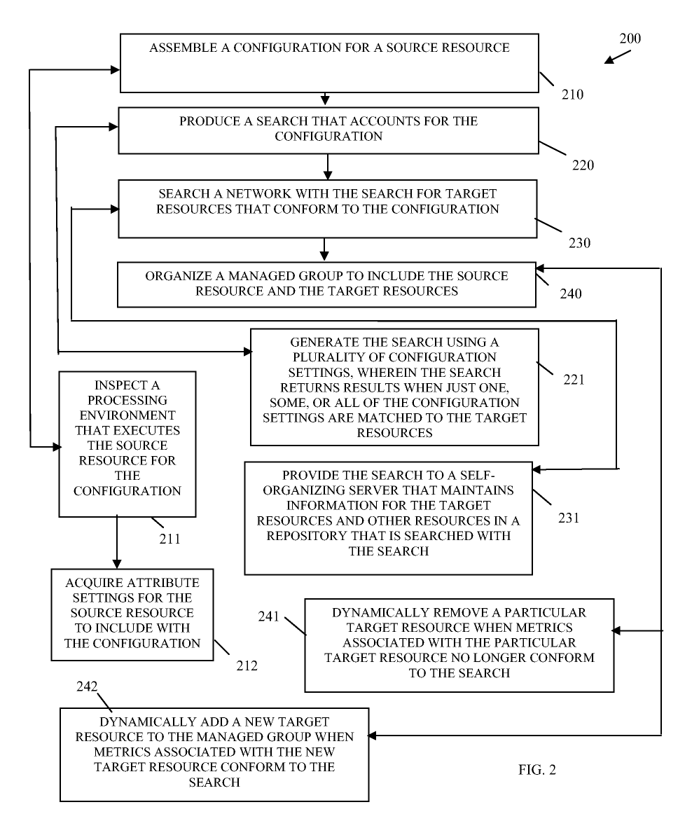

FIG. 2 is a diagram of another method 200 for locating and organizing similar resources of a network, according to an example embodiment. The method 200 (hereinafter “locator service” is implemented in a machine-accessible and readable medium as instructions. The instructions when executed by a machine perform the processing depicted in the FIG. 2. Moreover, the locator service is operational over a network, and the network may be wired, wireless, or a combination of wired and wireless.

At 210, the locator service assembles a configuration for a source resource. The configuration can be acquired via a variety of mechanisms, such as but not limited to the processing environment of the source resource, policy associated with the source resource, header details for the source resource, and the like.

In an embodiment, at 211, the locator service inspects the processing environment that executes the source resource for the configuration details.

Continuing with the embodiment at 211 and at 212, the locator service acquires attribute settings for the source resource to include with the configuration. Attribute settings can include such things as communicating over port N, using protocol X, etc.

At 220, the locator service produces a search that accounts for the configuration. This can be a complex search using a variety of custom Boolean logic or it may be a simple concatenated string of terms that define the configuration that is used as a WWW-based search via a WWW search engine.

According to an embodiment, at 221, the locator service generates the search using a plurality of configuration settings. The subsequent search (discussed at 230) returns just one, some, or all of the configuration settings found or matched to the target resources.

At 230, the locator service searches the network with the search to locate target resources that conform to the configuration of the search.

In an embodiment, at 231, the locator service provides the search to a self-organizing server that maintains information for the target resources and other resources in a repository that is searched with the search.

In another case, the locator service crawls the network by visiting the processing environments of each of the target resources to perform the search against install files, logs, and other information that may provide a match to the configuration being searched for.

At 240, the locator service organizes a managed group to include the source resource and the target resources. This group is dynamic and can change in real time as conditions change within the network.

Thus, at 241, the locator service can dynamically remove a particular one of the target resources from the managed group when metrics associated with that particular target resource no longer conform to the search, which defines the managed group.

Similarly, at 242, the locator service can dynamically add a new target resource to the managed group when metrics are discovered with the new target resource that conforms to the search.

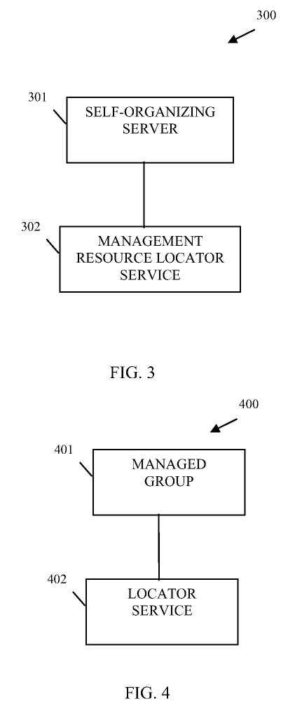

FIG. 3 is a diagram of self-organizing resource system 300, according to an example embodiment. The self-organizing resource system 300 is implemented in a machine-accessible and computer-readable storage medium as instructions. The instructions when executed by a machine (computer or processor-enabled device) perform the processing depicted in the FIGS. 1 and 2. Moreover, the self-organizing resource system 300 is operational over a network, and the network may be wired, wireless, or a combination of wired and wireless.

The self-organizing resource system 300 includes a self-organizing server 301 and a management resource locator service 302. Each of these and their interactions with one another will now be discussed in turn.

The self-organizing server 301 is implemented in a computer-readable storage medium as instructions that process on server machine (computer or processor-enabled device). Example aspects associated with the self-organizing server 301 was presented above with reference to the methods 100 and 200 of the FIGS. 1 and 2, respective.

The self-organizing server 301 collects information, which is associated with managed resources of an enterprise. In a sense, the self-organizing server 301 may be viewed as a passive and/active repository that is provided or that actively collects information regarding managed resources. This is a dynamic repository that is ever changing to reflect the current state of the resources.

The management resource locator service 302 is implemented in a computer-readable storage medium as instructions that process on a machine (computer or processor-enabled device) of the network. Example processing associated with the management resource locator service 302 was presented in detail above with reference to the methods 100 and 200 of the FIGS. 1 and 2, respective.

The management resource locator service 302 constructs a search to find a target resource that is similar to a source resource. The search is submitted to the self-organizing server 301. The results of the search returned from the self-organizing server 301 include a reference to the target resource. The management resource locator service 302 then self-organizes a managed group that includes the source resource and the target resource.

In an embodiment, the management resource locator service 302 forms the search by acquiring configuration settings for the source resource.

In another situation, the management resource locator service 302 forms the search by acquiring current processing environment characteristics for the processing environment that executes the source resource.

In yet another case, the management resource locator service 302 forms the search by acquiring policy that the source resource is subject to.

In one situation, the management resource locator service 302 reports the managed group and the search that formed the managed group to a network administrator for subsequent analysis and inspection.

According to an embodiment, the management resource locator service 302 is triggered automatically in response to a raised event that the management resource locator service 302 listens for within a processing environment of the source resource.

FIG. 4 is a diagram of another self-organizing resource system 400 according to an example embodiment. The self-organizing resource system 400 is implemented as instructions on or within a machine-accessible and computer-readable storage medium. The instructions when executed by one or more machines (computer(s) or processor-enabled device(s)) perform various aspects of the processing depicted with respect to the methods 100 and 200 of the FIGS. 1 and 2, respectively; and the system 300 of the FIG. 3. The self-organizing resource system 400 is also operational over a network and the network may be wired, wireless, or a combination of wired and wireless.

The self-organizing resource system 400 includes a managed group 401 and a locator service 402. Each of these components and their interactions with one another will now be discussed in turn.

Each resource of the managed group 401 is implemented in a computer-readable storage medium as instructions and is to be processed by a machine (computer or processor-enabled device) over the network. Example aspects of the managed group 401 were presented above in detail with reference to the methods 100 and 200 of the FIGS. 1 and 2, respectively, and with respect to the system 300 of the FIG. 3.

The managed group 401 is a set of references to managed resources of a network. The managed group 401 is dynamically established and modified by the locator service 402. Membership is dynamic and changes based on whether a particular member conforms to conditions and criteria defined by the locator service 402.

The locator service 402 is implemented in a computer-readable storage medium and is accessible to the managed resources and to other resources of the network. Some example aspects of the locator service 402 were presented in detail above with reference to the methods 100 and 200 of the FIGS. 1 and 2, respectively, and with respect to the system 300 of the FIG. 3.

The locator service 402 searches for target resources that are similar to a source resource. Searching can occur via a database, repository, cache, the entire network as a whole, etc. The locator service 402 then creates the managed group having the references to the target resources and the source resource. The locator service 402 monitors and manages the managed group 401 as a logical group.

According to an embodiment, the locator service 402 defines what is to be considered to be similar via one or more of: configuration settings for the source resource, processing characteristics for a processing environment of the source resource, and/or attributes associated with the source resource.

In one case, the locator service 402 consults a self-organizing server (such as the self-organizing server 301 of the FIG. 3) to discover the target resources and their references. The self-organizing server maintains an index of information for the target resources and other resources of the network. The self-organizing server returns the references in response to a search that the locator service 402 dynamically formulates to discover similar resources to the source resource.

In an embodiment, the locator service 402 constructs a search in response to a policy and uses the search to find the target resources. The locator service 402 can crawl the network and visit each processing environment for each target resource or can consult a centralized repository to conduct the search, such as the self-organizing server discussed above.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
receiving search criteria defining attributes of a source resource;
searching a self-organizing server with the search criteria;
receiving a target reference to a target resource, the target reference returned by the self-organizing server in response to the search criteria; and
adding the target reference to a managed group that includes a source reference to the source resource.

2. The method of claim 1, wherein receiving further includes representing the search criteria as current constraints or current configuration settings for the source resource.

3. The method of claim 1, wherein representing further includes dynamically acquiring the current constraints or current configuration settings from a processing environment of the source resource.

4. The method of claim 1, wherein receiving further includes receiving the search criteria from an administrator.

5. The method of claim 1, wherein receiving further includes receiving the search criteria from an automated service that is triggered to generate the search criteria when a predefined threshold value is detected as a particular value for one of the attributes of the source resource or when a scheduled time is reached.

6. The method of claim 1 further comprising, generating a report that identifies the managed group with the source reference and the target reference and that identifies the search criteria used to form the managed group.

7. The method of claim 1 further comprising, forming another second managed group of resources that includes members that do not conform to the search criteria and are not members of the managed group.

8. A machine-implemented method, comprising:
assembling a configuration for a source resource;
producing a search that accounts for the configuration;
searching a network with the search for target resources that conform to the configuration; and
organizing a managed group to include the source resource and the target resources.

9. The method of claim 8, wherein assembling further includes inspecting a processing environment that executes the source resource for the configuration.

10. The method of claim 9, wherein assembling further includes acquiring attribute settings for the source resource to include with the configuration.

11. The method of claim 8, wherein producing further includes generating the search using a plurality of configuration settings, wherein the search returns results when just one, some, or all of the configuration settings are matched to the target resources.

12. The method of claim 8, wherein searching further includes providing the search to a self-organizing server that maintains information for the target resources and other resources in a repository that is searched with the search.

13. The method of claim 8, wherein organizing further includes dynamically adding a new target resource to the managed group when metrics associated with the new target resource conform to the search.

14. The method of claim 8, wherein organizing further includes dynamically removing a particular target resource when metrics associated with the particular target resource no longer conform to the search.

15. A machine-implemented method, comprising:
a self-organizing server accessible over a network; and
a managed resource locator service implemented in a computer-readable storage medium and to process over the network;
wherein the self-organizing server collects information associated with managed resources of an enterprise and wherein the managed resource locator service constructs a search to find a target resource that is similar to a source resource, the search submitted to the self-organizing server, and the managed resource locator service forms a managed group that includes the source resource and the target resource.

16. The method of claim 15, wherein the managed resource locator service forms the search by acquiring configuration settings for the source resource.

17. The method of claim 15, wherein the managed resource locator service forms the search by acquiring current processing environment characteristics for a processing environment that executes the source resource.

18. The method of claim 15, wherein the managed resource locator service forms the search by acquiring a policy that the source resource is subject to.

19. The method of claim 15, wherein managed resource locator service reports the managed group and the search that formed the managed group to a network administrator.

20. The method of claim 15, wherein the managed resource locator service is triggered automatically in response to a raised event that the managed resource locator service listens for within a processing environment of the source resource.

21. A machine-implemented system, comprising a managed group implemented as references to managed resources within a computer-readable storage medium; and
a locator service implemented in a computer-readable storage medium that processes on a network;
wherein locator service searches for target resources that are similar to a source resource and then creates the managed group having the references to the target resources and the source resource, the managed group monitored and managed as a logical group.

22. The system of claim 21, wherein the locator service defines what is considered to be similar via one or more of: configuration settings for the source resource, processing characteristics for a processing environment of the source resource; and attributes associated with the source resource.

23. The system of claim 21, wherein the locator service consults a self-organizing server that maintains an index of information for the target resources and other resources of the network.

24. The system of claim 23, wherein the self-organizing server returns to the locator service the references in response to a search that the locator service forms.

25. The system of claim 21, wherein the locator service constructs a search in response to a policy and uses the search to find the target resources.
